(19) United States
(12) Patent Application Publication
(10) Pub. No.: US 2022/0389241 A1
(43) Pub. Date: Dec. 8, 2022

(54) ACID CATALYZED WATERBORNE RESIN

(71) Applicant: SWIMC LLC, Cleveland, OH (US)

(72) Inventors: Oscar TARNASEN, Uppsala (SE); Mathilda ENEBRO, Stockholm (SE); Yan HAO, Sollentuna (SE); Ingvar LINDH, Bromma (SE)

(21) Appl. No.: 17/664,998

(22) Filed: May 25, 2022

Related U.S. Application Data
(60) Provisional application No. 63/197,620, filed on Jun. 7, 2021.

(51) Int. Cl. C09D 7/20; C09D 7/61; C09D 179/02

(52) U.S. Cl. CPC C09D 7/20; C09D 7/61; C09D 179/02

(57) ABSTRACT

Provided herein is a waterborne resin composition comprising: 1) at least one binder resin comprising a hydroxyl-functional polymer, a carboxyl-functional polymer, a polyol, an amino-functional polymer, a carboxamide, or combinations thereof; and 2) at least one thermosetting resin, wherein the thermosetting resin comprises at least one aminoplast resin; wherein the waterborne resin composition is acid catalyzed. The waterborne resin composition may be a two-part system. Also described is a waterborne coating composition comprising the waterborne resin composition disclosed herein. Further, a process for preparing the waterborne coating composition is also disclosed.

### FIELD

The present disclosure relates generally to a waterborne resin composition comprising: 1) at least one binder resin comprising a hydroxyl-functional polymer, a carboxyl-functional polymer, a polyol, an amino-functional polymer, a carboxamide, or combinations thereof; and 2) at least one thermosetting resin, wherein the thermosetting resin comprises at least one aminoplast resin; wherein the waterborne resin composition is acid catalyzed. A method of preparing the waterborne resin composition described herein and a waterborne coating composition prepared from the waterborne resin described are also described.

### BACKGROUND

Conventionally, many acid-catalyzed wood coatings contain solvent-borne amino formaldehyde/glyoxal, alkyds, or combinations thereof, and are often combined with nitrocellulose to be catalyzed by adding acids, including strong acids. Typical acids may include those like hydrochloric acid (HCl), phosphoric acid (H₃PO₄), sulfuric acid (H₂SO₄), or combinations thereof as well as any derivatives of these acids. Often, these acids are used as part of a 2-part (2K) system. These wood coatings often require a hardener or catalyst to dry and cure. The solvent evaporates prior to and during the chemical reaction, and forms no part of the dried coating. Curing times of the acid-catalyzed solvent-borne coatings can be dramatically accelerated with the application of heat.

Acid-catalyzed solvent-borne coatings products typically have excellent application, curing, and stacking properties. These coatings are also known to produce hard, flexible, and chemical-resistant surfaces.

However, current environmental demands, including requirements for lower or zero VOC, are not possible with the conventional acid-catalyzed solvent-borne coatings. Additionally, there is a push for no or ultra-low formaldehyde emissions for both manufacturing facilities and customer end use. Formaldehyde and other toxic emissions are often regulated by laws, standards, and permits, so limiting these emissions from coatings may result in improved air quality both in factories, homes, and other facilities where applications are done.

In view of these challenges with conventional acid-catalyzed solvent-borne coatings, the need therefore remains for resins and coatings with lower volatile organic compounds (VOC) and formaldehyde emissions that are able to maintain performance properties as well as other advantages. Further, there is also a need for a method to prepare such coatings with the waterborne resin composition described as well as articles with such coatings.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

A waterborne resin composition comprising: 1) at least one binder resin comprising a hydroxyl-functional polymer, a carboxyl-functional polymer, a polyol, an amino-functional polymer, a carboxamide, or combinations thereof; and 2) at least one thermosetting resin, wherein the thermosetting resin comprises at least one aminoplast resin; wherein the waterborne resin composition is acid catalyzed.

The at least one binder resin is at least one acrylic resin, alkyd resin, polyurethane resin, acrylic-alkyd hybrid, acrylic-polyurethane hybrid, alkyd-polyurethane hybrid, or combinations thereof. The at least one binder resin may further comprise at least one acid, ammonium salt of acid, organic acid, Brönstedt's acid, Lewis acid, or combinations thereof.

The at least one aminoplast resin comprises at least one melamine resin, at least one urea resin, or combinations thereof.

A waterborne coating composition comprising the waterborne resin composition provided herein is also described. A process for preparing the waterborne coating composition provided herein is also described.

Additionally, an article is disclosed comprising: 1) a substrate having at least one surface; and 2) the waterborne coating composition described herein which is at least partially disposed on the at least one surface of the substrate; wherein the substrate comprises wood, wood composite, metal, plastic, paper, leather, fabric, ceramic, composite, or any combination thereof.

To the accomplishment of the foregoing and related ends, the following description set forth certain illustrative aspects and implementations. These are indicative of but a few of the various ways in which one or more aspects may be employed. Other aspects, advantages and novel features of the disclosure will become apparent from the following detailed description when considered.

### BRIEF DESCRIPTION OF THE DRAWINGS

The disclosure references the appended drawings. Advantages of embodiments of the application will be apparent from the following detailed description of the exemplary embodiments thereof, which description should be considered in conjunction with the accompanying drawings, in which:

FIG. 1 illustrates an exemplary configuration of the hardness testing measured using the Buchholz indentation (BH) testing according to ISO 2815:2003 between the solvent-borne acid cure samples and the waterborne acid cure samples for the treated samples described herein.

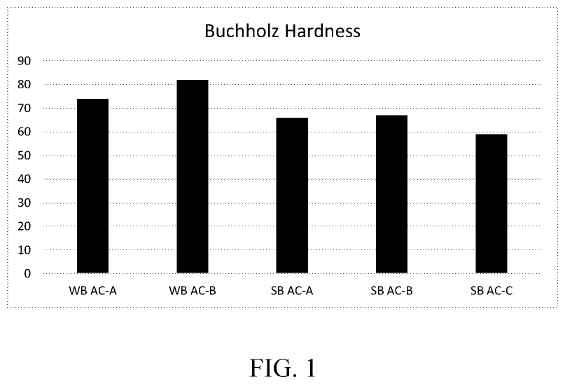

FIG. 2 illustrates an exemplary configuration of the hardness testing measured using the Buchholz indentation (BH) testing according to ISO 2815:2003 between the solvent-borne acid cure samples and the waterborne acid cure samples for the untreated samples described herein.

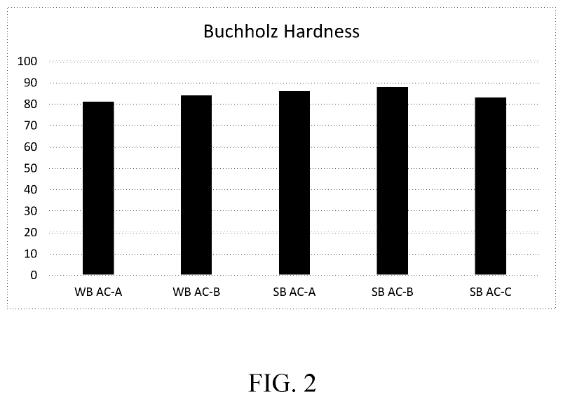

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to coatings systems, that provide advantageous improvements over current coatings. It has been discovered that a waterborne coating comprising an acid catalyzed waterborne resin can surprisingly lead to improved emissions, lower VOC's, and substantially maintained performance properties over solvent-borne coatings, as well as other advantages. As used herein, the term “acid catalyzed” may also be referred to as acid cured.

In many embodiments, a waterborne resin composition comprising: 1) at least one binder resin comprising a hydroxyl-functional polymer, a carboxyl-functional polymer, a polyol, an amino-functional polymer, a carboxamide, or combinations thereof and 2) at least one thermosetting resin, wherein the thermosetting resin comprises at least one aminoplast resin; wherein the waterborne resin composition is acid catalyzed. This acid catalyst, or salt thereof, in the waterborne resin composition may catalyze the condensation reaction such that high molecular weight polymers are produced in reasonable reaction times. Specifically, acid catalysts may help the reaction between the binder, e.g., a hydroxyl binder, and an amine-containing compound, e.g., an aminoplast.

### Binder Resin

In some embodiments, the binder resin comprises a hydroxy-functional polymer. In some embodiments, the binder resin comprises a carboxy-functional polymer. The backbone of these hydroxy-functional and carboxy-functional polymers may generally comprise acrylic resin, alkyd resin, polyurethane resin, acrylic-alkyd hybrid, acrylic-polyurethane hybrid, alkyd-polyurethane hybrid, or combinations thereof.

In some embodiments, the binder resin comprises a polyol. The polyol may comprise but is not limited to glycerol, trimethylolethane, trimethylolpropane, pentaerythritol, ethylene glycol, neopentyl glycol, or combinations thereof. Other polyols are also contemplated.

In some embodiments, the binder resin comprises an amino-functional polymer. In some embodiments, the binder resin comprises a carboxamide.

In many embodiments, at least one binder resin is at least partially water soluble, at least partially water soluble when added to at least one solvent, or at least partially dispersed in water. In some embodiments, the at least one solvent is water, an alcohol, a glycol, a polar aprotic solvent, a non-polar aprotic solvent, or combinations thereof. In some embodiments, the glycol is ethylene glycol, propylene glycol, dipropylene glycol n-butyl ether, or combinations thereof. In some embodiments, the alcohol is propanol, n-butylnol, or combinations thereof. In other embodiments, the polar aprotic solvent (meaning a solvent that contain bonds between atoms with very different electronegativities and have large dipole moments; they contain no hydrogen atoms connected directly to an electronegative atom and they are not capable of hydrogen bonding) is acetone, ethyl acetate, acetonitrile, toluene, dichloromethane, dimethylformamide (DMF), methyl sulfoxide, dimethylsulfoxide, N,N-dimethylpropyleneurea (DMPU), tetrahydrofuran, hexmethylphosphorictriamide, or combinations thereof. In yet other embodiments, the non-polar aprotic solvent (meaning a solvent that contains bonds between atoms with similar electronegativities and contain no hydrogen atoms connected directly to an electronegative atom, leaving them incapable of hydrogen bonding) is hexane, benzene, toluene, xylene, nitrobenzene, cyclohexane, diethylether, methyl acetate, ethyl acetate or combinations thereof. Other embodiments are also contemplated. In many embodiments, the at least one solvent in the waterborne coating composition may range from 0% to 10% by weight. In other embodiments, at least one solvent in the binder resin can, for example, range (by weight) from 0.5% to 10%, from 0.5% to 8%, from 0.5% to 7%, from 0.5% to 6%, from 0.5% to 5%, from 1% to 10%, from 1% to 9%, from 1% to 8%, from 1% to 7%, from 1% to 6%, from 1% to 5%, 2% to 10%, from 2% to 9%, from 2% to 8%, from 2% to 7%, from 2% to 6%, from 3% to 10%, from 3% to 9%, from 3% to 8%, from 3% to 7%, from 3% to 6%, from 3% to 5%, from 4% to 10%, from 4% to 9%, from 4% to 8%, from 4% to 7%, and from 4% to 6%.

In many embodiments, the at least one binder resin is at least one acrylic resin, alkyd resin, polyurethane resin, acrylic-alkyd hybrid, acrylic-polyurethane hybrid, alkyd-polyurethane hybrid, or combinations thereof. The hybrid resins described are a customized blend of various resins to create superior properties that allow the binder resin to be optimized.

In many embodiments, the at least one binder resin with a waterborne coating composition may range from 20% to 80% by weight. In other embodiments, at least one binder resin can, for example, range (by weight) from 20% to 75%, from 20% to 70%, from 20% to 65%, from 20% to 60%, from 25% to 80%, from 25% to 75%, from 25% to 70%, from 25% to 65%, from 25% to 60%, from 30% to 80%, from 30% to 75%, from 30% to 70%, from 30% to 65%, from 30% to 60%, from 40% to 80%, from 40% to 75%, from 40% to 70%, from 40% to 65%, from 40% to 60%, from 45% to 80%, from 45% to 75%, from 45% to 70%, from 45% to 65%, from 45% to 60%, from 50% to 80%, from 50% to 75%, from 50% to 70%, from 55% to 80%, from 55% to 75%, from 55% to 70%, from 60% to 80%, from 60% to 75%, and from 60% to 70%. Other ranges are also contemplated.

In many embodiments, the acrylic resin may be formed from methyl acrylate, ethyl acrylate, propyl acrylate, butyl acrylate, butyl methacrylate, 2-ethylhexyl acrylate, methyl methacrylate, methacrylic acid, ethyl methacrylate, propyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAEM), diacetone acrylamide (DAAM), acrylamide, methacrylamide, methylol (meth)acrylamide, styrene, a-methyl styrene, vinyl toluene, vinyl acetate, vinyl propionate, allyl methacrylate, or combinations thereof. Other monomers are also contemplated.

In many embodiments, the alkyd resin may be prepared by condensation reaction between at least one polyol and at least one polybasic acid. Polybasic acids may include but are not limited to phthalic anhydride, isophthalic acid, maleic anhydride, fumaric acid, or combinations thereof. Other polybasic acids are also contemplated. Polyols may include but are not limited to glycerol, trimethylolethane, trimethylolpropane, pentaerythritol, ethylene glycol, neopentyl glycol, or combinations thereof.

In many embodiments, the polyurethane resin may be formed by reacting a polyol (an alcohol with more than two reactive hydroxyl groups per molecule) with a diisocyanate or a polymeric isocyanate in the presence of suitable catalysts and additives. Polyols may include but are not limited to glycerol, trimethylolethane, trimethylolpropane, pentaerythritol, ethylene glycol, neopentyl glycol, or combinations thereof. Other polyols are also contemplated.

In some embodiments, at least one binder resin may be a polyurea.

In many embodiments, at least one binder resin further comprises at least one acid, ammonium salt of acid, organic acid, Brönstedt's acid, Lewis acid, or combinations thereof.

### Aminoplast Resin

In many embodiments, the at least one aminoplast resin comprises at least one melamine resin, at least one urea resin, or combinations thereof. Other aminoplast resins are also contemplated. In some embodiments, the at least one aminoplast resin comprises at least one aldehyde. In some embodiments, at least one aldehyde of the at least one aminoplast resin is formaldehyde, glyoxal, or combinations thereof. In other embodiments, at least one aldehyde may comprise formaldehyde, glyoxal, acetaldehyde (ethanal), propionaldehyde (propanal), butyraldehyde (butanal), benzaldehyde (phenylmethanal), glutaraldehyde, or combinations thereof. Other aldehydes are also contemplated.

In many embodiments, the at least one aminoplast resin with a waterborne coating composition may range from 3% to 50% by weight. In other embodiments, at least one aminoplast resin can, for example, range (by weight) from 3% to 40%, from 5% to 50%, from 5% to 40%, from 5% to 35%, from 7% to 50%, from 7% to 45%, from 7% to 40%, from 7% to 35%, from 10% to 50%, from 10% to 45%, from 10% to 40%, from 10% to 35%, from 10% to 30%, from 10% to 25%, from 15% to 50%, from 15% to 45%, from 15% to 40%, from 15% to 35%, from 15% to 30%, and from 15% to 25%. Other ranges are also contemplated.

In many embodiments, the at least one aminoplast resin is at least partially water soluble, at least partially water soluble when added to at least one solvent, or at least partially dispersed in water. In some embodiments, the at least one solvent is water, an alcohol, a glycol, a polar aprotic solvent, a non-polar aprotic solvent, or combinations thereof. In some embodiments, the glycol is ethylene glycol, propylene glycol, or combinations thereof. In some embodiments, the alcohol is propanol, n-butylnol, or combinations thereof. In other embodiments, the polar aprotic solvent (meaning a solvent that contain bonds between atoms with very different electronegativities and have large dipole moments; they contain no hydrogen atoms connected directly to an electronegative atom and they are not capable of hydrogen bonding) is acetone, ethyl acetate, acetonitrile, toluene, dichloromethane, dimethylformamide (DMF), methyl sulfoxide, dimethylsulfoxide, N,N′-dimethylpropyleneurea (DMPU), tetrahydrofuran, hexmethylphosphorictriamide, or combinations thereof. In yet other embodiments, the non-polar aprotic solvent (meaning a solvent that contains bonds between atoms with similar electronegativities and contain no hydrogen atoms connected directly to an electronegative atom, leaving them incapable of hydrogen bonding) is hexane, benzene, toluene, xylene, nitrobenzene, cyclohexane, diethylether, methyl acetate, ethyl acetate or combinations thereof. Other embodiments are also contemplated. In many embodiments, the at least one solvent in the waterborne coating composition may range from 0% to 10% by weight. In other embodiments, at least one solvent in the binder resin can, for example, range (by weight) from 0.5% to 10%, from 1% to 10%, from 0.5% to 10%, from 2% to 10%, from 1% to 9%, from 2% to 9%, from 2% to 8%, from 2% to 7%, from 2% to 6%, from 3% to 10%, from 3% to 9%, from 3% to 8%, from 3% to 7%, from 3% to 6%, from 3% to 5%, from 4% to 10%, from 4% to 9%, from 4% to 8%, from 4% to 7%, and from 4% to 6%. Other ranges are also contemplated.

In many embodiments, the at least one aminoplast resin comprises alkyl ether groups of at least one alkyl group, alkyl ester groups of at least one alkyl group, or combinations thereof. In some embodiments, any formaldehyde in the at least one aminoplast resin is minimized. In some embodiments, at least one aminoplast resin has substantially no formaldehyde. In other embodiments, the at least one aminoplast resin contains no formaldehyde.

In some embodiments, the waterborne resin composition is a two-component system. In other embodiments, the waterborne resin composition is a one-component system.

### Waterborne Coating

In many embodiments, a waterborne coating composition comprising the waterborne resin composition described herein. In many embodiments, the waterborne coating composition may further comprise at least one thickener, defoamer, surfactant, dispersant, solvent, antimicrobial agent, pigment, wax, UV absorber, scavenger, fire retardant, hardener, or combinations thereof. Other additives are also contemplated.

In many embodiments, the waterborne coating composition is cured at a temperature ranging from 20° C. to 130° C. In other embodiments, curing the waterborne coating composition described herein can, for example, range in temperature from 20° C. to 125° C., from 20° C. to 120° C., from 20° C. to 110° C., from 25° C. to 125° C., from 25° C. to 120° C., from 25° C. to 110° C., from 30° C. to 130° C., from 30° C. to 120° C., from 30° C. to 115° C., from 30° C. to 110° C., from 35° C. to 125° C., from 35° C. to 120° C., from 35° C. to 115° C., from 35° C. to 110° C., from 40° C. to 130° C., from 40° C. to 120° C., from 40° C. to 110° C., from 45° C. to 130° C., from 45° C. to 125° C., from 45° C. to 120° C., and from 40° C. to 110° C. In other embodiments, drying the waterborne coating may performed at temperatures higher than 130° C. Temperatures lower than 20° C. are also contemplated.

In many embodiments, the waterborne coating composition is cured by heat, infrared, or combinations thereof. Other curing methods are also contemplated.

### Process 1

In many embodiments, a process for preparing the waterborne coating composition described herein may comprise: 1) combining at least one binder resin having a pH of 1 to 10 and at least one thermosetting resin to form a resin blend; and 2) adding at least one catalyst to the resin blend. In other embodiments, the pH of at least one binder resin can, for example, range from 1 to 9, from 1 to 8, from 1 to 7, from 1 to 6, from 1 to 5, from 2 to 10, from 2 to 9, from 2 to 8, from 2 to 7, from 2 to 6, from 2 to 5, from 3 to 10, from 3 to 9, from 3 to 8, from 3 to 7, from 3 to 6, from 3 to 5, from 4 to 10, from 4 to 9, from 4 to 8, from 4 to 7, from 4 to 6, from 4 to 5, from 5 to 10, from 5 to 9, from 5 to 8, from 5 to 7, from 5 to 6, from 6 to 10, from 6 to 9, from 6 to 8, from 6 to 7, from 7 to 10, from 7 to 9, from 8 to 10, and from 8 to 9. In some embodiments, the process may further comprise the step of neutralizing at least one binder resin to a pH of 5 to 10 prior to combining the at least one binder resin with at least one thermosetting resin. In one embodiment, the step of neutralizing at least one binder resin may be adjusted to a pH of 6 to 10. In another embodiment, the step of neutralizing at least one binder resin may be adjusted to a pH of 7 to 10. Other ranges are also contemplated. In some embodiments, the at least one binder resin is neutralized by at least one amine. In some embodiments, the amine may be a primary amine. In other embodiments, the amine may be a secondary amine. In yet other embodiments, the amine may be a tertiary amine. The amine of the acrylic emulsion may also be a combination of different amines. In some embodiments, the amine is ammonia, methylamine, diethylamine, triethylamine, and combinations thereof. Other amines are also contemplated.

In some embodiments, the at least one catalyst is at least one acid, ammonium salt of acid, organic acid, Brönstedt's acid, Lewis acid, or combinations thereof.

In one embodiment, the at least one catalyst is dissolved in at least one solvent prior to adding at least one catalyst to the resin blend. In yet another embodiment, the at least one solvent is water, an alcohol, a glycol, a polar aprotic solvent, a non-polar aprotic solvent, or combinations thereof. In some embodiments, the glycol is ethylene glycol, propylene glycol, or combinations thereof. In some embodiments, the alcohol is propanol, n-butylnol, or combinations thereof. In other embodiments, the polar aprotic solvent (meaning a solvent that contain bonds between atoms with very different electronegativities and have large dipole moments; they contain no hydrogen atoms connected directly to an electronegative atom and they are not capable of hydrogen bonding) is acetone, ethyl acetate, acetonitrile, toluene, dichloromethane, dimethylformamide (DMF), methyl sulfoxide, dimethylsulfoxide, N,N′-dimethylpropyleneurea (DMPU), tetrahydrofuran, hexmethylphosphorictriamide, or combinations thereof. In yet other embodiments, the non-polar aprotic solvent (meaning a solvent that contains bonds between atoms with similar electronegativities and contain no hydrogen atoms connected directly to an electronegative atom, leaving them incapable of hydrogen bonding) is hexane, benzene, toluene, xylene, nitrobenzene, cyclohexane, diethylether, methyl acetate, ethyl acetate or combinations thereof. Other embodiments are also contemplated. In many embodiments, the at least one solvent in the waterborne coating composition may range from 0% to 10% by weight. In other embodiments, at least one solvent in the binder resin can, for example, range (by weight) from 0.5% to 10%, from 1% to 10%, from 0.5% to 10%, from 2% to 10%, from 1% to 9%, from 2% to 9%, from 2% to 8%, from 2% to 7%, from 2% to 6%, from 3% to 10%, from 3% to 9%, from 3% to 8%, from 3% to 7%, from 3% to 6%, from 3% to 5%, from 4% to 10%, from 4% to 9%, from 4% to 8%, from 4% to 7%, and from 4% to 6%.

### Process 2

In many embodiments, a process for preparing the waterborne coating composition described herein may comprise: 1) adding at least one catalyst to at least one binder resin to form a catalyst binder resin blend, wherein the catalyst binder resin blend has a pH of 1 to 7; and 2) adding at least one thermosetting resin to the catalyst binder resin blend.

### Process 3

In many embodiments, a process for preparing the waterborne coating composition described herein may comprise: 1) adding at least one binder resin having a pH of 1 to 7 to at least one thermosetting resin.

In some embodiments, the process of preparing the waterborne coating composition described herein may further comprise the step of: neutralizing at least one binder resin prior to combining the at least one binder resin with at least one thermosetting resin. In some embodiments, the at least one binder resin is neutralized by at least one amine. In some embodiments, the amine may be a primary amine. In other embodiments, the amine may be a secondary amine. In yet other embodiments, the amine may be a tertiary amine. The amine of the acrylic emulsion may also be a combination of different amines. In some embodiments, the amine is ammonia, methylamine, diethylamine, triethylamine, and combinations thereof. Other amines are also contemplated. In some embodiments, the process of preparing the waterborne resin composition described herein may further comprise the step of: adding at least one catalyst to at least one binder resin prior to adding the at least one binder resin having a pH of 1 to 7 to the at least one thermosetting resin. In one embodiment, the at least one catalyst is dissolved in at least one solvent prior to adding at least one catalyst to the binder resin. In some embodiments, the at least one solvent is water, an alcohol, a glycol, a polar aprotic solvent, a non-polar aprotic solvent, or combinations thereof. In some embodiments, the glycol is ethylene glycol, propylene glycol, or combinations thereof. In some embodiments, the alcohol is propanol, n-butylnol, or combinations thereof. In other embodiments, the polar aprotic solvent (meaning a solvent that contain bonds between atoms with very different electronegativities and have large dipole moments; they contain no hydrogen atoms connected directly to an electronegative atom and they are not capable of hydrogen bonding) is acetone, ethyl acetate, acetonitrile, toluene, dichloromethane, dimethylformamide (DMF), methyl sulfoxide, dimethylsulfoxide, N,N′-dimethylpropyleneurea (DMPU), tetrahydrofuran, hexmethylphosphorictriamide, or combinations thereof. In yet other embodiments, the non-polar aprotic solvent (meaning a solvent that contains bonds between atoms with similar electronegativities and contain no hydrogen atoms connected directly to an electronegative atom, leaving them incapable of hydrogen bonding) is hexane, benzene, toluene, xylene, nitrobenzene, cyclohexane, diethylether, methyl acetate, ethyl acetate or combinations thereof. Other embodiments are also contemplated. In many embodiments, the at least one solvent in the waterborne coating composition may range from 0% to 10% by weight. In other embodiments, at least one solvent in the binder resin can, for example, range (by weight) from 0.5% to 10%, from 1% to 10%, from 0.5% to 10%, from 2% to 10%, from 1% to 9%, from 2% to 9%, from 2% to 8%, from 2% to 7%, from 2% to 6%, from 3% to 10%, from 3% to 9%, from 3% to 8%, from 3% to 7%, from 3% to 6%, from 3% to 5%, from 4% to 10%, from 4% to 9%, from 4% to 8%, from 4% to 7%, and from 4% to 6%.

In many embodiments, an article comprising: 1) a substrate having at least one surface; and 2) the waterborne coating composition of described herein at least partially disposed on the at least one surface of the substrate. In many embodiments, the substrate comprises wood, wood composite, metal, plastic, paper, leather, fabric, ceramic, composite, or any combination thereof. In some embodiments, the wood comprises pine, birch, beech, acacia, oak, walnut, or combinations thereof. In some embodiments, the substrate may be a wood composite. In many embodiments, the wood composite is MDF, HDF, THDF, Particle board, Plywood, and combinations thereof. Other wood species and wood composites are also contemplated.

Test Results

The waterborne coating composition described herein comprising the waterborne resin composition described herein and shown below in Table 1.

TABLE 1

| Component | Weight % |
|---|---|
| Hydroxyl functional acrylic resin | 55 |
| Neutralization agent | 0.2 |
| Pigment Paste | 25 |
| Solvents | 4 |
| Wetting agents & defoamers | 2 |
| Matting agents | 3 |
| Aminoplast 1 | 3 |
| Aminoplast 2 | 7 |
| Thickening agent | 0.8 |

The waterborne coating composition in the following test results was acid catalyzed (referred to as acid cure). The benchmark product is a standard solvent-borne acid cure product.

For chemical resistance, the results were evaluated according to IOS EN 12720. For the waterborne acid catalyzed (also referred to waterborne acid cure) product with curing agent Y (an acid solution in water is used as the only curing agent in these examples) in ratio 100:6 and the pH was in the range of about 2.2 to 2.8. Test performed 4 days after application, results were analyzed 24 hours after removal of test liquid. The substrate was a fiber board with foil which was sprayed with the products. Curing was 4 minutes at 60° C. followed by 1 minute IR until surface temperature was between 90-100° C. However, the hand cream is evaluated using a modified test method but still evaluated according to EN ISO 12720. For hand cream, 1 g of hand cream is used with a contact time of 24 hours, and then detergent solution described under EN 12720 is applied for 2 minutes with an evaluation 24 hours after cleaning with the detergent solution. Based on the results are shown below in Table 2, both the solvent-borne acid cure and the waterborne acid have similar chemical resistance results.

TABLE 2

| | | | | | Hand |
|---|---|---|---|---|---|
| | Coffee | Alcohol | Water | Fat | Cream |
| Product | 1 h | 1 h | 24 h | 24 h | 24 h |
| Solventborne Acid Cure | 4 | 5 | 5 | 5 | 3 |
| Waterborne Acid Cure | 4 | 4 | 4 | 5 | 5 |

Further, hand cream was also evaluated using the Buchholz indentation evaluation method. Both cure time and surface temperature are recorded. For this testing, the hand cream is evaluated using a modified test method but still evaluated according to EN ISO 12720. For hand cream, 1 g of hand cream on the back of a Petri dish (Ø=6 cm) is used with a contact time of 24 hours, and then detergent solution described under EN 12720 is applied for 2 minutes with an evaluation immediately after cleaning with the detergent solution. Hardness is measured using the Buchholz indentation (BH) testing according to ISO 2815:2003. Indentation depth (ID) in micrometers is also recorded. Several formulations of waterborne acid cure (labeled A and B) and solvent-borne acid cure (labeled A, B, and C) were tested on both treated using hand cream applied for 24 hours and then cleaned for 2 minutes prior to evaluation (Table 3. and Chart 1) and untreated without any hand cream (Table 4. and Chart 2) samples.

TABLE 3
Treated Samples

| Technology | Curing | Surf temp | | BH | ID* | Resistance to nail scratch |
|---|---|---|---|---|---|---|
| Waterborne Acid Cure-A | 5 min 80° C. | 55-60° | C. | 74 | 14 | Not indentable, not peelable |
| Waterborne Acid Cure-B | 4 min 60° C. + IRM | 95° | C. | 82 | 12 | Not indentable, not peelable |

| | | | | | |
|---|---|---|---|---|---|
| Solvenborne Acid Cure-A | Std drying for SB AC | — | 66 | 18 | Not peelable, barely indentable (high |
| | | | | | load required) |
| Solvenborne Acid Cure-B | Std drying for SB AC | — | 67 | 18 | Not peelable, barely indentable (high |
| | | | | | load required) |
| Solvenborne Acid Cure-C | Std drying for SB AC | — | 59 | 23 | Not peelable, barely indentable |
| | | | | | (medium/high load required) |

*Indentation Depth in micrometers

TABLE 4
Untreated Samples

| Technology | Curing | Surf temp | | BH | ID* | Resistance to nail scratch |
|---|---|---|---|---|---|---|
| Waterborne Acid Cure- | 5 min 80° C. | 55-60° | C. | 81 | 11 | Not indentable, not peelable |
| A | | | | | | |
| Waterborne Acid Cure- | 4 min 60° C. + IRM | 95° | C. | 84 | 11 | Not indentable, not peelable |
| B | | | | | | |

| | | | | | |
|---|---|---|---|---|---|
| Solvenborne Acid Cure- | Std drying for SB | — | 86 | 11 | Not indentable, not peelable |
| A | AC | | | | |
| Solvenborne Acid Cure- | Std drying for SB | — | 88 | 10 | Not indentable, not peelable |
| B | AC | | | | |
| Solvenborne Acid Cure- | Std drying for SB | — | 83 | 12 | Not indentable, not peelable |
| C | AC | | | | |

*Indentation Depth in micrometers

Based on the results for both treated (Table 3. and Chart 1) and untreated (Table 4. and Chart 2) samples, there were differences between the solvent-borne acid cure samples and the waterborne acid cure samples for the treated samples. Neither the solvent-borne acid cure samples nor the waterborne acid cure samples were peelable. However, the solvent-borne acid cure samples were barely indentable but the waterborne acid cure samples were not indentible. For the untreated samples, the waterborne acid cure technology sample performed similar to the solvent-borne acid cure samples. Overall, the waterborne acid cure samples performed at least comparable if not improved over the benchmark solvent-borne products.

### Embodiments

The following embodiments are contemplated. All combinations of features and embodiments are contemplated.

Embodiment 1: A waterborne resin composition comprising: 1) at least one binder resin comprising a hydroxyl-functional polymer, a carboxyl-functional polymer, a polyol, an amino-functional polymer, a carboxamide, or combinations thereof; and 2) at least one thermosetting resin, wherein the thermosetting resin comprises at least one aminoplast resin; wherein the waterborne resin composition is acid catalyzed.

Embodiment 2: An embodiment of Embodiment 1, wherein at least one binder resin is at least partially water soluble, at least partially water soluble when added to at least one solvent, or at least partially dispersed in water.

Embodiment 3: An embodiment of Embodiment 2, wherein the at least one solvent is water, an alcohol, a glycol, a polar aprotic solvent, a non-polar aprotic solvent, or combinations thereof.

Embodiment 4: An embodiment of any of Embodiments 1-3, wherein the at least one binder resin is at least one acrylic resin, alkyd resin, polyurethane resin, acrylic-alkyd hybrid, acrylic-polyurethane hybrid, alkyd-polyurethane hybrid, or combinations thereof.

Embodiment 5: An embodiment of any of Embodiments 1-4, wherein at least one binder resin further comprises at least one acid, ammonium salt of acid, organic acid, Brönstedt's acid, Lewis acid, or combinations thereof.

Embodiment 6: An embodiment of any of Embodiments 1-5, wherein the at least one aminoplast resin comprises at least one melamine resin, at least one urea resin, or combinations thereof.

Embodiment 7: An embodiment of any of Embodiments 1-6, wherein that at least one aminoplast resin comprises at least one aldehyde.

Embodiment 8: An embodiment of any of Embodiments 1-7, wherein the at least one aminoplast resin is at least partially water soluble, at least partially water soluble when added to at least one solvent, or at least partially dispersed in water.

Embodiment 9: An embodiment of Embodiment 8, wherein the at least one solvent is water, an alcohol, a glycol, a polar aprotic solvent, a non-polar aprotic solvent, or combinations thereof.

Embodiment 10: An embodiment of any of Embodiments 1-9, wherein the at least one aminoplast resin comprises alkyl ether groups of at least one alkyl group, alkyl ester groups of at least one alkyl group, or combinations thereof.

Embodiment 11: An embodiment of any of Embodiments 1-10, wherein at least one aldehyde of the at least one aminoplast resin is formaldehyde, glyoxal, or combinations thereof.

Embodiment 12: An embodiment of any of Embodiments 1-11, further comprising at least one catalyst.

Embodiment 13: An embodiment of Embodiment 12, wherein the at least one catalyst is at least one acid, ammonium salt of acid, organic acid, Brönstedt's acid, Lewis acid, or combinations thereof.

Embodiment 14: An embodiment of Embodiment 13, wherein the at least one catalyst is a neutralized catalyst.

Embodiment 15: An embodiment of any of Embodiments 12-14, wherein the at least one catalyst has a pKa value between −9 and 10.

Embodiment 16: An embodiment of any of Embodiments 1-15, wherein the waterborne resin composition is a two-component system.

Embodiment 17: A waterborne coating composition comprising the waterborne resin composition of any of Embodiments 1-16.

Embodiment 18: An embodiment of Embodiment 17, wherein the waterborne coating composition is cured at a temperature ranging from 20° C. to 130° C.

Embodiment 19: An embodiment of Embodiment 18, wherein the waterborne coating composition is cured by heat, infrared, or combinations thereof.

Embodiment 20: An embodiment of any of Embodiments 17-19 further comprising at least one thickener, defoamer, surfactant, dispersant, solvent, antimicrobial agent, pigment, wax, UV absorber, scavenger, fire retardant, hardener, or combinations thereof.

Embodiment 21: A process for preparing the waterborne coating composition of any of Embodiments 17-20 comprising: 1) combining at least one binder resin having a pH of 1 to 10 and at least one thermosetting resin to form a resin blend; and 2) adding at least one catalyst to the resin blend.

Embodiment 22: An embodiment of Embodiment 21 further comprising the step of: neutralizing at least one binder resin to a pH of 5 to 10 prior to combining the at least one binder resin with at least one thermosetting resin.

Embodiment 23: An embodiment of any of Embodiments 21-22, wherein the at least one catalyst is at least one acid, ammonium salt of acid, organic acid, Brönstedt's acid, Lewis acid, or combinations thereof.

Embodiment 24: An embodiment of any of Embodiments 21-23, wherein the at least one catalyst is dissolved in at least one solvent prior to adding at least one catalyst to the resin blend.

Embodiment 25: An embodiment of Embodiment 24, wherein the at least one solvent is water, an alcohol, a glycol, a polar aprotic solvent, a non-polar aprotic solvent, or combinations thereof.

Embodiment 26: A process for preparing the waterborne coating composition of any of Embodiments 17-20 comprising: 1) adding at least one catalyst to at least one binder resin to form a catalyst binder resin blend, wherein the catalyst binder resin blend has a pH of 1 to 7; and 2) adding at least one thermosetting resin to the catalyst binder resin blend.

Embodiment 27: A process for preparing the waterborne coating composition of any of Embodiments 17-20 comprising: 1) adding at least one binder resin having a pH of 1 to 7 to at least one thermosetting resin.

Embodiment 28: An embodiment of Embodiment 27 further comprising the step of: neutralizing at least one binder resin prior to combining the at least one binder resin with at least one thermosetting resin.

Embodiment 29: An embodiment of any of Embodiments 27-28 further comprising the step of: adding at least one catalyst to at least one binder resin prior to adding the at least one binder resin having a pH of 1 to 7 to the at least one thermosetting resin.

Embodiment 30: An embodiment of Embodiment 29, wherein the at least one catalyst is dissolved in at least one solvent prior to adding at least one catalyst to the binder resin.

Embodiment 31: An embodiment of Embodiment 30, wherein the at least one solvent is water, an alcohol, a glycol, a polar aprotic solvent, a non-polar aprotic solvent, or combinations thereof.

Embodiment 32: An article comprising: 1) a substrate having at least one surface; and 2) the waterborne coating composition of any of Embodiments 17-20 at least partially disposed on the at least one surface of the substrate; wherein the substrate comprises wood, wood composite, metal, plastic, paper, leather, fabric, ceramic, composite, or any combination thereof.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A waterborne resin composition comprising:
at least one binder resin comprising a hydroxyl-functional polymer, a carboxyl-functional polymer, a polyol, an amino-functional polymer, a carboxamide, or combinations thereof; and
at least one thermosetting resin, wherein the thermosetting resin comprises at least one aminoplast resin;
wherein the waterborne resin composition is acid catalyzed.

2. The waterborne resin composition of claim 1, wherein at least one binder resin is at least partially water soluble, at least partially water soluble when added to at least one solvent, or at least partially dispersed in water.

3. The waterborne resin composition of claim 2, wherein the at least one solvent is water, an alcohol, a glycol, a polar aprotic solvent, a non-polar aprotic solvent, or combinations thereof.

4. The waterborne resin composition of claim 1, wherein the at least one binder resin is at least one acrylic resin, alkyd resin, polyurethane resin, acrylic-alkyd hybrid, acrylic-polyurethane hybrid, alkyd-polyurethane hybrid, or combinations thereof.

5. The waterborne resin composition of claim 1, wherein at least one binder resin further comprises at least one acid, ammonium salt of acid, organic acid, Brönstedt's acid, Lewis acid, or combinations thereof.

6. The waterborne resin composition of claim 1, wherein that at least one aminoplast resin comprises at least one melamine resin, at least one urea resin, or combinations thereof.

7. The waterborne resin composition of claim 1, wherein that at least one aminoplast resin comprises at least one aldehyde.

8. The waterborne resin composition of claim 1, wherein the at least one aminoplast resin is at least partially water soluble, at least partially water soluble when added to at least one solvent, or at least partially dispersed in water.

9. The waterborne resin composition of claim 8, wherein the at least one solvent is water, an alcohol, a glycol, a polar aprotic solvent, a non-polar aprotic solvent, or combinations thereof.

10. The waterborne resin composition of claim 1, wherein the at least one aminoplast resin comprises alkyl ether groups of at least one alkyl group, alkyl ester groups of at least one alkyl group, or combinations thereof.

11. The waterborne resin composition of claim 1, wherein at least one aldehyde of the at least one aminoplast resin is formaldehyde, glyoxal, or combinations thereof.

12. The waterborne resin composition of claim 1, further comprising at least one catalyst.

13. The waterborne resin composition of claim 12, wherein the at least one catalyst is at least one acid, ammonium salt of acid, organic acid, Brönstedt's acid, Lewis acid, or combinations thereof.

14. The waterborne resin composition of claim 12, wherein the at least one catalyst is a neutralized catalyst.

15. The waterborne resin composition of claim 12, wherein the at least one catalyst has a pKa value between −9 and 10.

16. The waterborne resin composition of claim 1, wherein the waterborne resin composition is a two-component system.

17. A waterborne coating composition comprising the waterborne resin composition of claim 1.

18. The waterborne coating composition of claim 17, wherein the waterborne coating composition is cured at a temperature ranging from 20° C. to 130° C.

19. The waterborne coating composition of claim 17, wherein the waterborne coating composition is cured by heat, infrared, or combinations thereof.

20. The waterborne coating composition of claim 17 further comprising at least one thickener, defoamer, surfactant, dispersant, solvent, antimicrobial agent, pigment, wax, UV absorber, scavenger, fire retardant, hardener, or combinations thereof.

21. A process for preparing the waterborne coating composition of claim 17 comprising:
combining at least one binder resin having a pH of 1 to 10 and at least one thermosetting resin to form a resin blend; and
adding at least one catalyst to the resin blend.

22. The process for preparing the waterborne coating composition of claim 21 further comprising the step of:
neutralizing at least one binder resin to a pH of 5 to 10 prior to combining the at least one binder resin with at least one thermosetting resin.

23. The process for preparing the waterborne coating composition of claim 21, wherein the at least one catalyst is at least one acid, ammonium salt of acid, organic acid, Brönstedt's acid, Lewis acid, or combinations thereof.

24. The process for preparing the waterborne coating composition of claim 21, wherein the at least one catalyst is dissolved in at least one solvent prior to adding at least one catalyst to the resin blend.

25. The process for preparing the waterborne coating composition of claim 24, wherein the at least one solvent is water, an alcohol, a glycol, a polar aprotic solvent, a non-polar aprotic solvent, or combinations thereof.

26. A process for preparing the waterborne coating composition of claim 17 comprising:
adding at least one catalyst to at least one binder resin to form a catalyst binder resin blend, wherein the catalyst binder resin blend has a pH of 1 to 7; and
adding at least one thermosetting resin to the catalyst binder resin blend.

27. A process for preparing the waterborne coating composition of claim 17 comprising:
adding at least one binder resin having a pH of 1 to 7 to at least one thermosetting resin.

28. The process for preparing the waterborne coating composition of claim 27 further comprising the step of:
neutralizing at least one binder resin prior to combining the at least one binder resin with at least one thermosetting resin.

29. The process for preparing the waterborne coating composition of claim 27 further comprising the step of:
adding at least one catalyst to at least one binder resin prior to adding the at least one binder resin having a pH of 1 to 7 to the at least one thermosetting resin.

30. The process for preparing the waterborne coating composition of claim 29, wherein the at least one catalyst is dissolved in at least one solvent prior to adding at least one catalyst to the binder resin.

31. The process for preparing the waterborne coating composition of claim 30, wherein the at least one solvent is water, an alcohol, a glycol, a polar aprotic solvent, a non-polar aprotic solvent, or combinations thereof.

32. An article comprising:
a substrate having at least one surface; and
the waterborne coating composition of claim 17 at least partially disposed on the at least one surface of the substrate;
wherein the substrate comprises wood, wood composite, metal, plastic, paper, leather, fabric, ceramic, composite, or any combination thereof.
